(19) United States
(12) Patent Application Publication
(10) Pub. No.: US 2018/0068035 A1
(43) Pub. Date: Mar. 8, 2018

(54) MODELING AND DESIGNING SYSTEM AND METHOD

(71) Applicant: BRAND SHARED SERVICES LLC, Kennesaw, GA (US)

(72) Inventors: Mike WHITE, Pasadena, TX (US); Rick DUNLAP, Pasadena, TX (US)

(73) Assignee: BRAND SHARED SERVICES LLC, Kennesaw, GA (US)

(21) Appl. No.: 15/699,165

(22) Filed: Sep. 8, 2017

Related U.S. Application Data
(60) Provisional application No. 62/521,725, filed on Jun. 19, 2017.
(60) Provisional application No. 62/384,958, filed on Sep. 8, 2016.

(51) Int. Cl. G06F 17/50

(52) U.S. Cl. CPC G06F 17/5004

(57) ABSTRACT

Improved modeling and imaging systems and methods for designing scaffolding systems for a project site. A multi-dimensional spatial model of the project site is obtained. This model can be created using a laser scanner that collects point-cloud data. Software is used to design a scaffolding system based on the project-site model, integrate/apply the scaffolding design to the project-site model to generate an output combination scaffold design and project-site model, and improve the scaffolding design based on a review of the combination model. In typical embodiments, the system and method are also capable of creating cost estimates, materials lists, georeferenced tags, and building plans for the improved scaffolding design.

### CROSS-REFERENCE TO RELATED APPLICATION

This application claims the priority benefit of U.S. Provisional Patent Application Ser. No. 62/521,725 filed Jun. 19, 2017, and U.S. Provisional Patent Application Ser. No. 62/384,958 filed Sep. 8, 2016, which are hereby incorporated herein by reference.

### TECHNICAL FIELD

The present invention relates generally to the field of computer-implemented construction design systems and methods, and more particularly to a modeling and imaging system and method for designing scaffolding systems.

### BACKGROUND

Scaffolding is used in a variety of applications, for example for elevated access in new and renovation construction projects of many types. Previously known methods of planning scaffold installations can be very time-consuming and inefficient to perform. This is particularly an issue for very large and highly complex construction projects such as power plants, oil and gas refineries, sports stadiums, industrial facilities, and the like. Traditional manual design techniques are extremely laborious, and while modern computer-implemented design software generally provides for increased productivity and accuracy, there nevertheless remains opportunity for further improvements.

For example, scaffolding design services have been provided by Brand Energy & Infrastructure Services, Inc. using a well-regarded computer-implemented design software system known as the BRANDNET tool. Scaffolding design software such as this can be used to generate a scaffolding design model (for example based on scopes (e.g., access locations) identified in an existing CAD model of a project site) and output a project-management work package. Such project-management work packages can include drawings, materials lists, material cost estimates, labor cost estimates, work schedules (e.g., Gantt charts and/or work breakdown structures), etc. While scaffolding design software such as this has proven to be highly successful, it would be advantageous if further increases in productivity and/or accuracy in scaffolding design could be obtained, particularly for very large and highly complex construction projects such as power plants, oil and gas refineries, sports stadiums, industrial facilities, and the like.

Accordingly, it can be seen that needs exists for improvements in the field of planning and designing of scaffolding systems. It is to the provision of these and related solutions that the present invention is primarily directed.

### SUMMARY

Generally described, the present invention relates to a modeling and imaging system and method for scaffold design, which may be used to reduce costs and increase productivity and accuracy. In example embodiments, the invention provides an at least partially automated computer-implemented modeling and imaging system and method for designing a scaffolding system for a project site. The system and method optionally further provide for generating an optimized scaffold system design by using an integration and review process, as well as generating a parts list, cost and labor estimates, georeferenced tags, and building plans, and/or other output information and data related to the output optimized scaffold design.

In one aspect, the invention relates to a modeling and imaging system for scaffold system design. The system can include a laser scanner configured to collect point-cloud data from a project site where scaffolding is to be installed, a first computer-implemented software module that converts the point-cloud data to a multi-dimensional model of the project site, and a second computer-implemented software module for creating a scaffolding design, and which optionally generates parts lists, cost and labor estimates, and/or other information related to the scaffold design. The project-site model from the first computer-implemented software module and the scaffolding design from the second computer-implemented software module can be integrated in order to optimize the scaffolding design. In some embodiments, the integration is performed by importing the project-site model from the first computer-implemented software module into the second computer-implemented software module, and in other embodiments it is performed by exporting the scaffolding design from the second computer-implemented software module into the first computer-implemented software module. In some embodiments, the project-site model is existing and obtained for use by the system so the laser scanner need not be included and the first computer-implemented software module need not include the capability of converting the raw point-cloud data into the project-site model.

In another aspect, the invention relates to a modeling and imaging method for designing a scaffolding system for a project site. The method includes obtaining a multi-dimensional model of a project site, creating a scaffolding design for the project site based on the project-site model, integrating the scaffolding design and the project-site model to generate an output combination scaffold design and project-site model, and improving the scaffolding design based on a review of the combination model. In an example embodiment, the project-site model is imported into a computer-implemented software module for scaffolding design that creates the scaffolding design and integrates the scaffolding design and project-site model. In other embodiments, the scaffolding design model is exported from the software module and integrated with the project-site model. In some embodiments, the project-site model is generated using laser-scanning equipment and a computer-implemented software module for converting raw point-cloud data from the laser-scanning equipment into the project-site model. And in other embodiments, the project-site model is existing, or obtained in another conventional way, and available for use in the method.

These and other aspects, features, and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIG. 1 is an overview process flow diagram of a scaffold modeling and designing method according to example embodiments of the present invention.

FIG. 2 is a detailed process flow diagram of portions of the scaffold modeling and designing method of FIG. 1 according to a first example embodiment of the present invention.

FIG. 3 is a perspective view of example laser scanning equipment suitable for use to obtain a new project-site model in the method of FIG. 2.

FIG. 4 is a screen display of an example point-cloud depiction of a portion of a project site created using the laser scanning equipment of FIG. 3.

FIG. 5 is a screen display of a portion of an example 2.5-dimensional model of a portion of a project site created from the point-cloud depiction of FIG. 4.

FIG. 6 is a screen display of another portion of an example a 2.5-dimensional model of the project site created from the point-cloud depiction of FIG. 4.

FIG. 7 is a schematic flow diagram showing two example methods for identifying and planning project scopes according to the scaffold modeling and designing method of FIG. 2.

FIG. 8 is a schematic diagram showing example elements of a scopes package created based on the scopes identified in the method of FIG. 7.

FIG. 9 is a schematic flow diagram showing example steps of creating a scaffolding design in the method of FIG. 2.

FIG. 10 is a screen display of a portion of an example 3-dimensional combination model of a portion of the scaffolding design of FIG. 9 integrated with a portion of the project-site model of FIGS. 5-6 according to the method of FIG. 2.

FIGS. 11A-11D are four screen displays of four different portions of the 3-dimensional combination scaffolding design and project-site model of FIG. 10.

FIGS. 12A-12B are two screen displays showing georeferenced representations of a portion of the 3-dimensional combination scaffolding design and project-site model of FIG. 10.

FIG. 13 is a screen display showing a georeferenced representation of a portion of the 3-dimensional combination scaffolding design and project-site model of FIG. 10.

FIG. 14 is a schematic view of software output elements of a project management work package according to the method of FIG. 2.

FIGS. 15A-15B are two screen displays of portions of the project management work package of FIG. 14.

FIG. 16 is schematic flow diagram of an example readable tagging feature according to an example embodiment of the present invention.

FIG. 17 is a detailed process flow diagram of portions of the scaffold modeling and designing method of FIG. 1 according to a second example embodiment of the invention.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

Generally described, the present invention relates to a method and system for designing scaffolding systems for a project site. The method and system can be used for designing scaffolding systems of any conventional type for providing access to desired locations and elements of the project site. The method and system can be used for designing scaffolding systems for any conventional type of project site including but not limited to very large and highly complex construction projects such as power plants, oil and gas refineries, sports stadiums, industrial facilities, other plants or facilities, or the like. And the method and system can be adapted for use in designing other temporary systems used in the construction of such construction projects, for example shoring and forming systems.

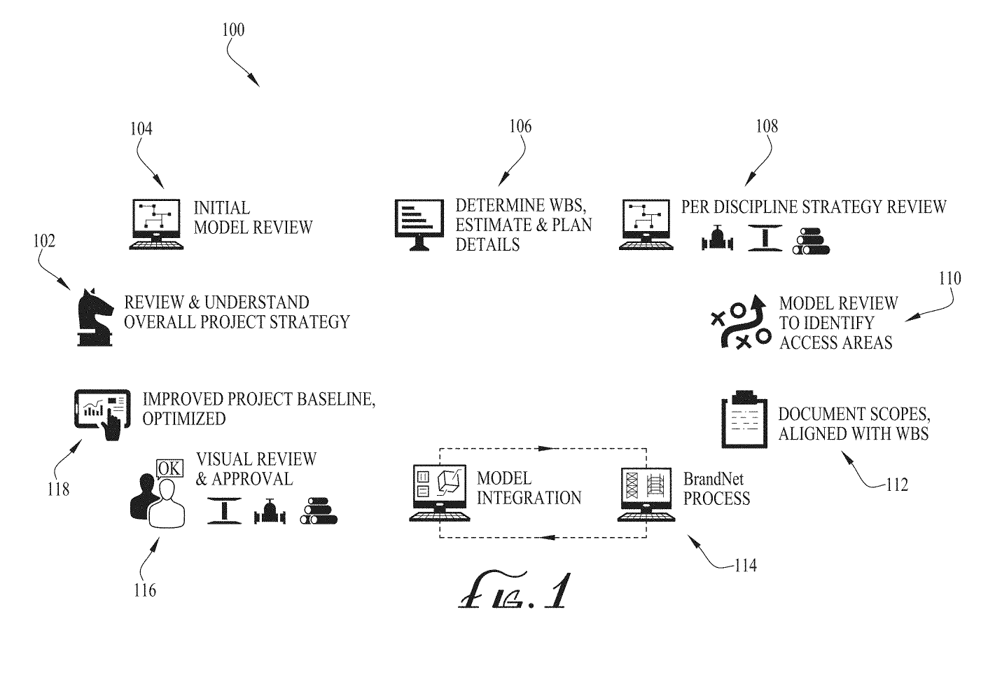

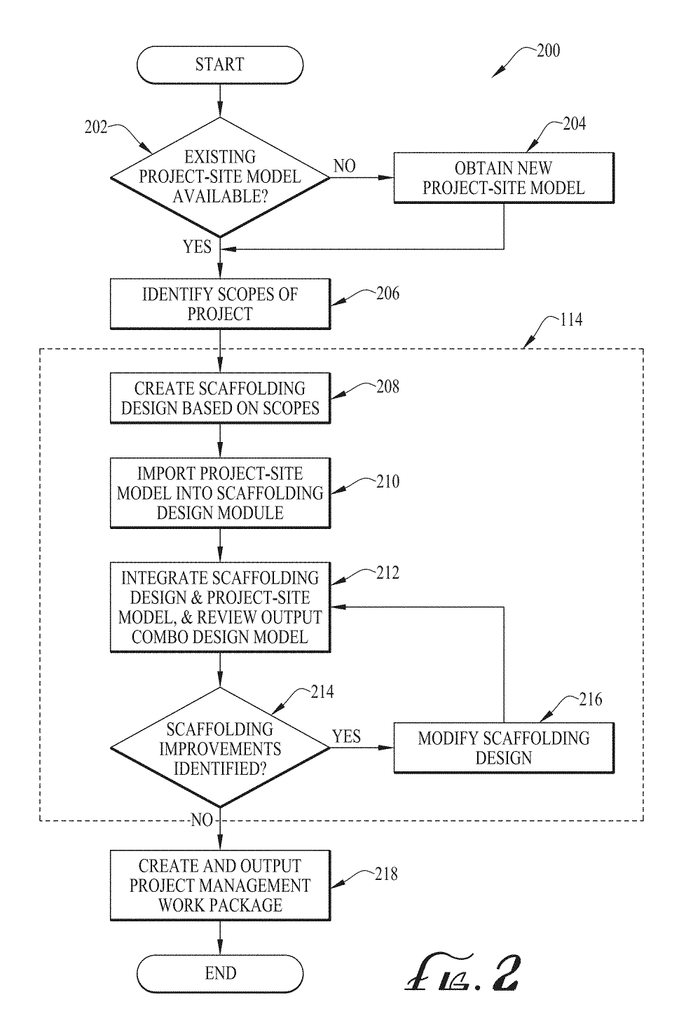

Turning now to the drawings, FIGS. 1-17 show various features and aspects of example embodiments of the design method and system. FIG. 1 shows a top-level overview of the example scaffolding design method 100, and FIG. 2 shows a detailed design and improvement method 200 according to a first example embodiment, which includes the model-integration method 114 of and can be part of the overall scaffold design method 100.

Referring now to FIG. 1, the example overall scaffold design method 100 provides for optimization planning that produces value creation. The example overall scaffold design method 100 includes at 102 reviewing and understanding the overall project strategy, at 104 conducting an initial review of a model of the project site, at 106 determining the work breakdown structure (WBS) and estimating and planning details, and at 108 conducting a strategy review per discipline. Then at 110 the project-site model is reviewed to identify the scopes (including access locations), and at 112 the scopes are documented and aligned with the WBS. Then at 114 a scaffolding design software system is used to design a scaffolding system based on the identified scopes, the project-site model and the scaffolding design are integrated into a combination scaffolding design and project-site model, the combination scaffolding design and project-site model is reviewed for design issues with the scaffolding, and the scaffolding design is modified/improved to resolve those issues and reintegrated with the project-site model into a modified/improved combination scaffolding design and project-site model. Next at 116 the improved combination scaffolding design and project-site model is reviewed by the client and the scaffolding design is approved, resulting at 118 in an optimized (or at least improved) project plan for the scaffold design.

It will be understood that the overall scaffold design method 100 can be implemented using less than all of the disclosed steps, using modified versions of at least some of these steps, and/or using additional steps not disclosed herein, provided that the model-integration method 200 (or another model-integration model embodiment) is included. That is, each the model-integration methods of the various embodiments disclosed herein can be provided by itself or with only some of the steps of the overall design method 100. It will also be understood that reference herein to the BRANDNET tool is for illustration purposes only, and thus the invention is not limited to using only this scaffolding design software.

FIG. 2 shows a detail model-integration method 200 that can be included as part of the example overall scaffold design method 100. For example, site-model obtaining steps 202 and 204 can be generally included in the initial model review step 104 of FIG. 1, scope-identification step 206 can correspond to the access-identifying step 110 of FIG. 1, and work-package output step 218 can be included in the conclusion step 118 of FIG. 1. In addition, expanded subroutine steps 208, 210, 212, 214, and 216 show example details of the model-integration step 114 of FIG. 1.

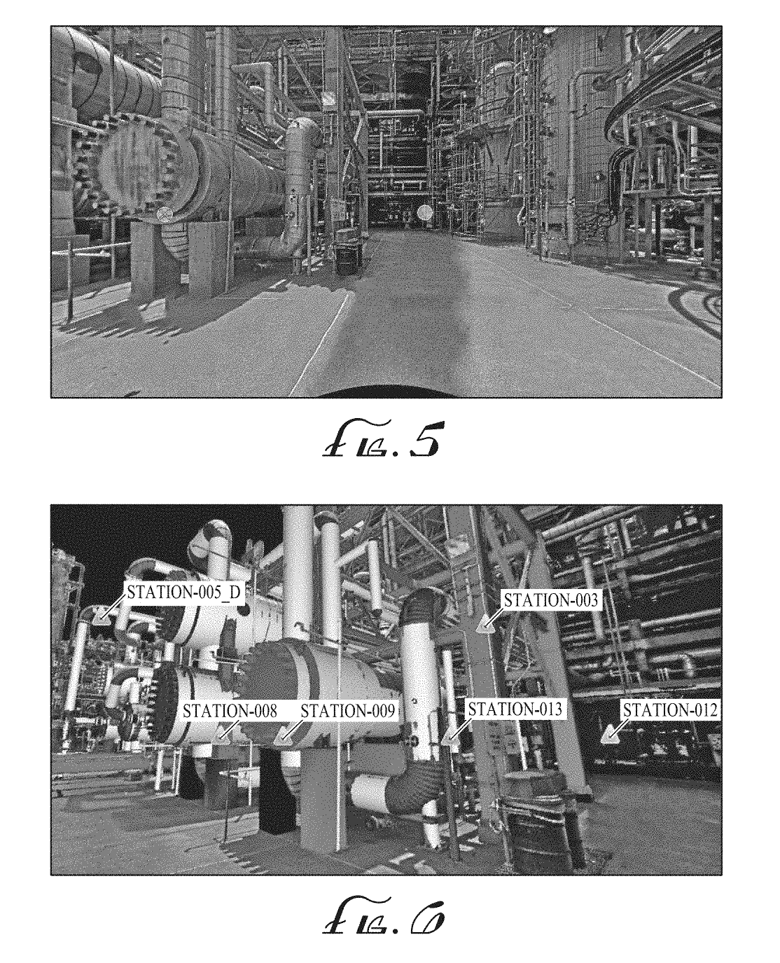

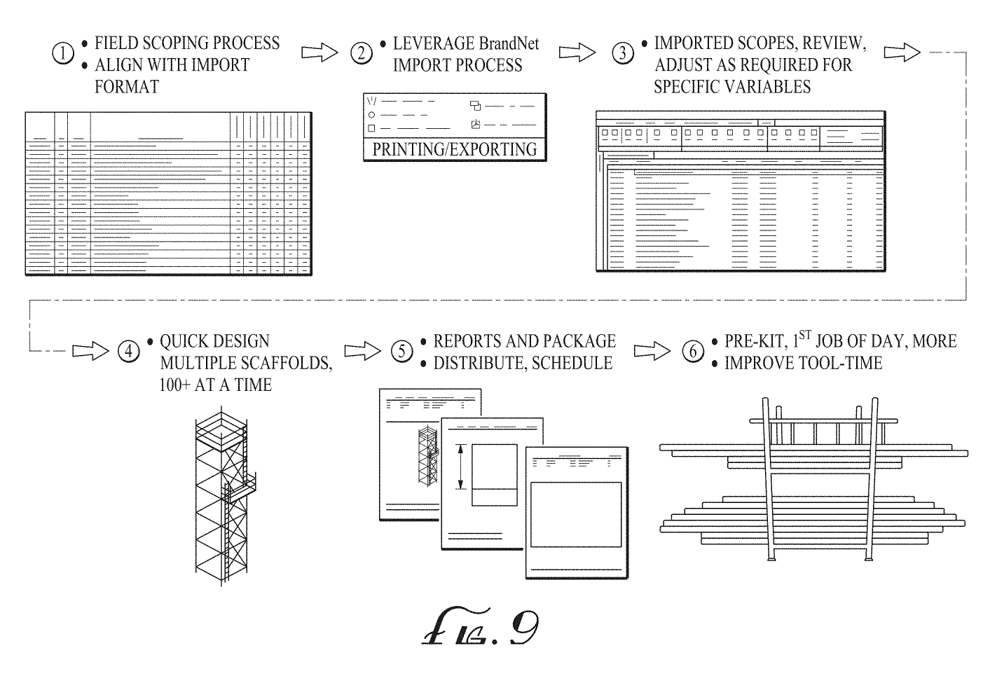

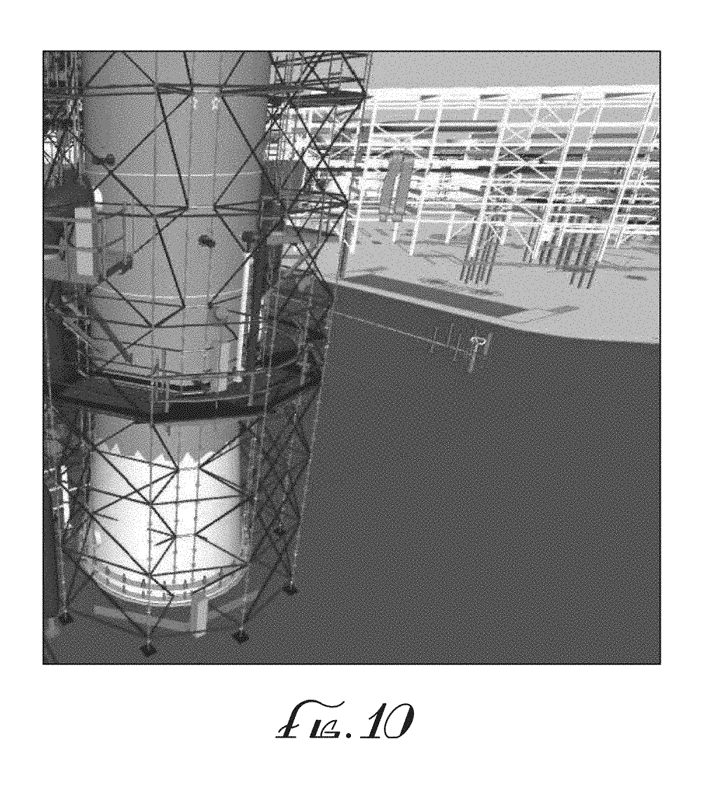

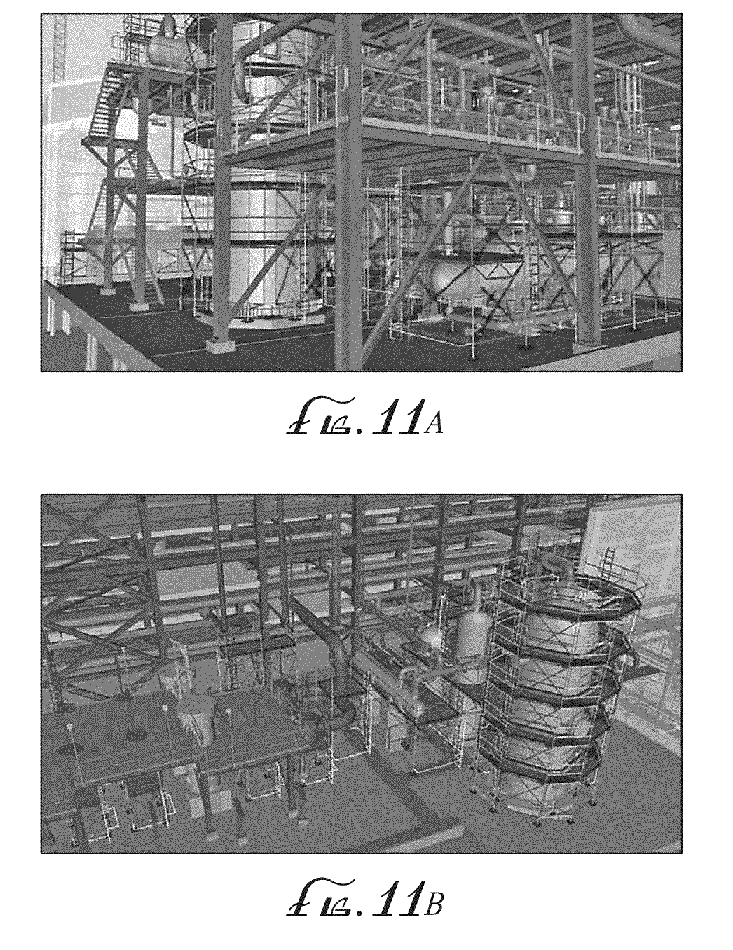

The method 200 begins at 202, where a designer (e.g., a firm contracted to design and install a scaffolding system for the project site) determines if a multi-dimensional model of the project site is available (e.g., as part of the initial model review of step 104). The multi-dimensional project-site model can be a 3-dimensional (3-D) model (as depicted in FIGS. 10-11) or a 2.5-dimensional model (2.5D) (e.g., as depicted in FIGS. 5-6). A 2.5-D model is a two-dimensional (2-D) image generated by using projection and other techniques to cause the image to simulate the appearance of being 3-dimensional but essentially spatially aware of coordinates and/or measurements (a 2.5-D image appears to the viewer to have spatial depth and includes coordinates enabling 3-D measurements). Alternatively, the project-site model can be another “multi-dimensional spatial” model that is 3-D or that simulates the appearance of being 3-D but is not actually 3-D. The project-site model typically includes a data file including information that represents the project site and that can be processed and displayed (for example on a display screen of an electronic device such as a desktop, laptop, or tablet computer), and that can be manipulated (for example by using conventional interfaces such as pointing devices and keypads). Suitable multi-dimensional project-site models can be made using conventional 3-D CAD systems such as the AUTODESK system and/or the NAVISWORKS system (by Autodesk Inc. of San Rafael, Calif.), and the SMARTPLANT REVIEW system (by Intergraph Corporation of Madison, Ala.).

Such project-site models are sometimes created as part of the design process for the original/new construction of the plant or facility. In other cases, no such model was created for constructing the facility (particularly for older projects), but were created for use in a later renovation of the project site. Such project-site models are sometimes referred to as building information models (Ms), and thus a conventional BIM can be used in this step. In any event, if a project-site model is existing (and available) at 202, then the method proceeds to step 206.

But if a project-site model is not existing or available at 202, then at 204 the designer obtains a new multidimensional project-site model. The model can be created directly by the same party conducting the design method 200 or this task can be outsourced to another party (but still controlled by the designing party). In typical embodiments, the new project-site model is created using conventional 3-D laser-scanning equipment, for example LFM equipment (by LFM Software Limited of Manchester, UK), AUTODESK RECAP equipment (by Autodesk Inc. of San Rafael, Calif.), or FARO FOCUS equipment (by FARO Technologies UK Limited of Warwickshire, UK).

Example 3-D laser-scanning equipment is shown in FIG. 3. Generally, the laser-scanning process includes first identifying coordinate systems with known parameters, such as at least one physical landmark on the project site, to geo-reference the data captured to the known project-site parameters. If no or insufficient landmarks are available for this use, then at least one project-specific landmark can be identified and used to geo-reference the data captured to the project site. For example, a major structural element of the project, such as a main column in a pipe-rack, can be used as a landmark to which all the data captured is referenced.

Next, a number of scan locations in the facility are identified for sequentially placing the laser scanner (of the laser-scanning equipment) in order to provide sufficient data-collection points for imaging of the entire facility, and then laser scan targets (of the laser-scanning equipment) are set up in the facility in an overlapping arrangement so that they overlap scans from adjacent scan locations (to define overlapping “breadcrumbs” related to the geospatial locations of the scan targets for use by the scan-processing software that processes the scan data), with at least one of the scan targets being at least one of the landmarks. Then the scanner is placed at one of the scan locations, operated to take a scan, repositioned at another scan location, operated to take another scan, and so on, with the process repeated until the entire project site has been scanned, with the captured scan date saved on a conventional data storage device (of the laser-scanning equipment).

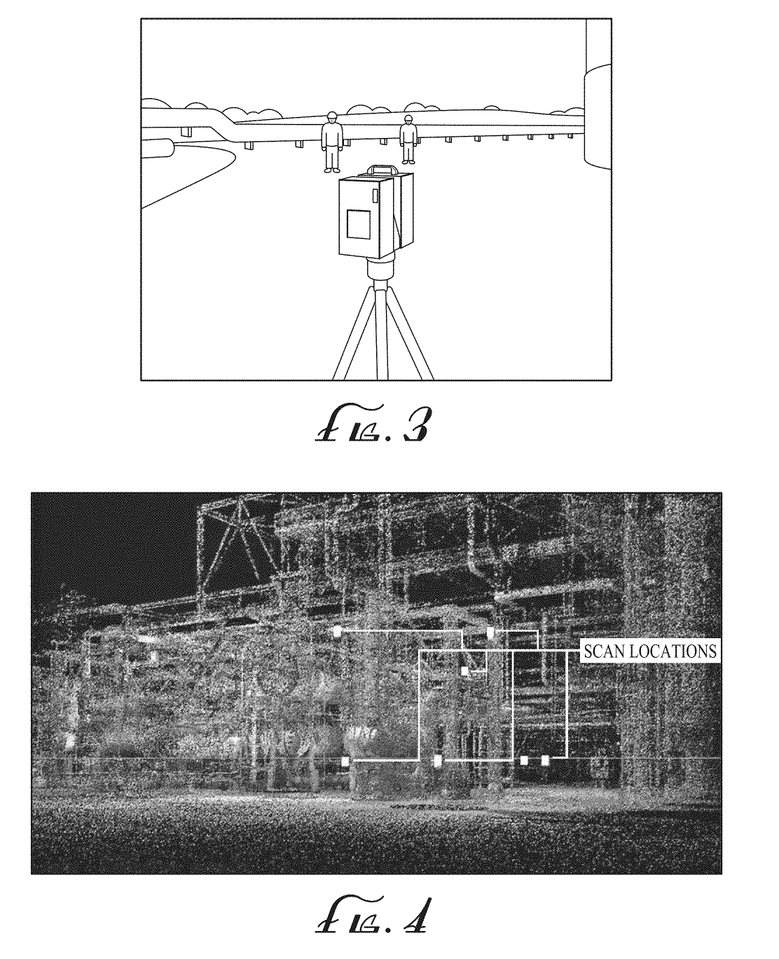

The scan-processing software (of the laser-scanning equipment) uses the “breadcrumbs” to stitch together the scan data captured from the various scanner placement locations. Typically, the captured scan data is processed by the software to create a point cloud representation of the project site (for example see FIG. 4), which is in turn used to create a multi-dimensional spatial (e.g., 2.5-D or 3-D) model of the project site (for example see FIGS. 5-6) using the same or other conventional software. Any of a variety of different scan-processing software packages can be used to process the captured scan data, for example LFM software (by AVEVA Solutions Ltd of Manchester, UK), AUTODESK RECAP equipment (by Autodesk Inc. of San Rafael, Calif.), or LEICA CYCLONE equipment (by Leica Geosystems AG of Heerbrugg, Switzerland). While such scan-processing software is known and has been used for engineering plant design, it is not known to have been used for virtual planning and especially not for virtual scaffolding planning as described herein.

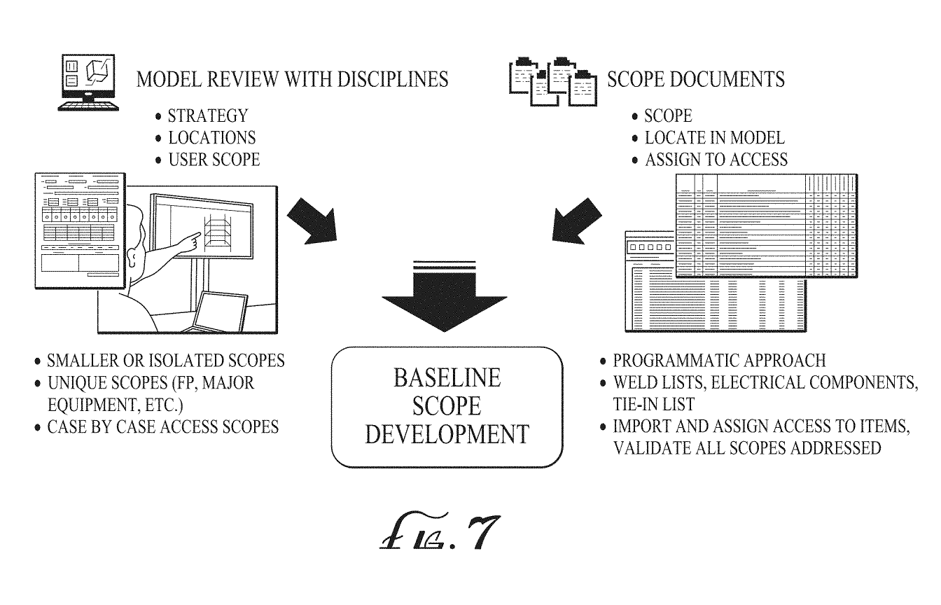

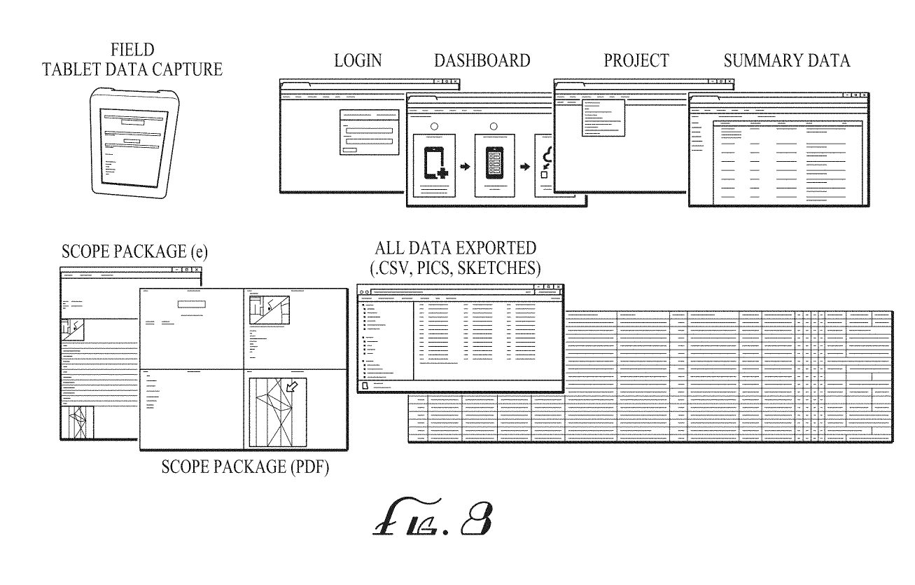

At this point in the method 200, the project-site model is on hand, whether it was existing/available at 202 or newly obtained at 204. So the method 200 continues at 206 with the designer identifying and planning the scopes of the project. The scopes typically include access locations where workers will need to access certain on-site elements (for example elevated welding points or electrical elements) by using (being supported by) the scaffolding system to reach and work. In addition, the scopes can be considered to include dimensional and positional information of the project site that is needed for designing scaffolding that when installed on the project site is stable and enables workers to reach the access locations. As used herein, the term “scopes” is intended to be given its customary meaning in the field of construction design generally and particularly scaffolding design. Example details of the scope development process are shown in FIGS. 7-8.

In addition, the scopes can be identified manually or using the project-site model, for example as shown in FIG. 7. The scopes can be selected manually by locating access points, etc., and taking measurements in person physically on the project site. Or the scopes can be selected on a conventional computer (e.g., with a processor, an operating system, memory storage, input and output devices, and CAD software) by accessing and manipulating the project-site model to locate access points, etc., and take measurements. For example, the scopes can be determined based on the locations of electrical elements, welds, etc., identified in the project-site model and/or by viewing weld lists or tie-in lists associated with the project-site model. In some embodiments, the scaffolding-design software includes features for importing the project-site model and identifying/selecting the scopes, the project-site model is imported into the same computer having the scaffolding design software (as described below), and the importing is done before step 206 instead of later at step 210. In any event, once the scopes are selected, they can be reviewed by the designer and adjusted as required for specific variables. A scopes package can then be generated using the scaffolding design software, for example as detailed in FIG. 8.

Next, at 208 the designer uses the scaffolding design software to design a scaffolding system for the project site based on the identified scopes. The scaffolding design software can be run on a conventional computer (e.g., with a processor, an operating system, memory storage, and input and output devices) and is operable for planning, modeling, and designing a scaffolding system for installation on the project site. An example of such a scaffolding design software system is the BRANDNET tool (by Brand Energy & Infrastructure Services, Inc. of Kennesaw, Ga.), though other scaffolding design software could foreseeably be used provided that they include the capability to design a custom scaffolding system for a specific project site.

Conventional scaffolding design software (such as the BRANDNET tool) includes a library of 3-D models of individual scaffold parts and elements, which can be used to create a variable-geometry 3-D model of a scaffold system configured for installation on the project site to enable worker access to the scoped access locations. With the variable-geometry feature and the library of element models, the designer can quickly and easily modify the scaffolding design model as may be desired to best accommodate the scopes of the project. Thus, such example scaffolding design software can be used to seamlessly arrange, re-arrange, and re-size the individual virtual scaffold parts to accommodate the desired access locations or other scope elements. And such example scaffolding design software typically includes the capability of creating estimates based on the scaffolding systems (cost, materials, man hours, etc.). Example details of this part of the scaffolding design process are shown in FIG. 9. As such suitable scaffolding CAD software and processes are well known in the art, further details are not included for efficiency and brevity of this specification.

Next, at 210, the designer imports the project-site model into the scaffolding design software system. The example scaffolding design software includes the capability of importing the project-site model. Persons of ordinary skill in the art are capable of designing and implementing this importing feature in computer software. Of course, the project-site model can be imported into the scaffolding design software system earlier, before the scope are selected at step 206 and the scaffolding system is designed at step 208.

Once the scaffolding design is completed and the project-site model is imported, at 212 the designer uses the scaffolding design software to integrate the scaffolding design model and the project-site model into a combination multi-dimensional spatial model of the scaffolding and the project site (see for example FIGS. 10 and 11A-D). The example scaffolding design software includes the capability of applying/overlaying the custom-designed scaffolding design model onto the project-site model (or otherwise integrating the two for viewing together). Persons of ordinary skill in the art are capable of designing and implementing this integrating/overlaying feature in computer software.

The scaffolding design software outputs the combination scaffolding/project model to a display screen (e.g., of the computer with the scaffolding design software) to allow the designer to view the virtual scaffolding system installed at the virtual project site prior to actual construction. This virtual viewing/planning feature better enables the designer, using the computer with the scaffolding design software, to identify potential problem areas caused by the scaffolding design at 214 (by viewing the display), modify the scaffolding design at 216 (by using the scaffolding design software), and reintegrate the modified scaffolding design model and the project-site model into an improved version of the combination scaffold/project model (by using the scaffolding design software). Examples of such possible problem areas include interference between the scaffolding and other site locations (e.g., cranes, welding machines, ladders, stored materials, and/or other construction equipment or materials, and roadways, pathways, worker areas, and/or other areas that need to be kept clear for access by workers and equipment) needed for use during other aspects of the construction/renovation of the project facility. This process can be repeated until a final version of the scaffolding design is achieved. This unique process improves the scaffolding design, which reduces on-site modifications and rebuilds, thereby improving productivity and reducing waste such as crew stand-by.

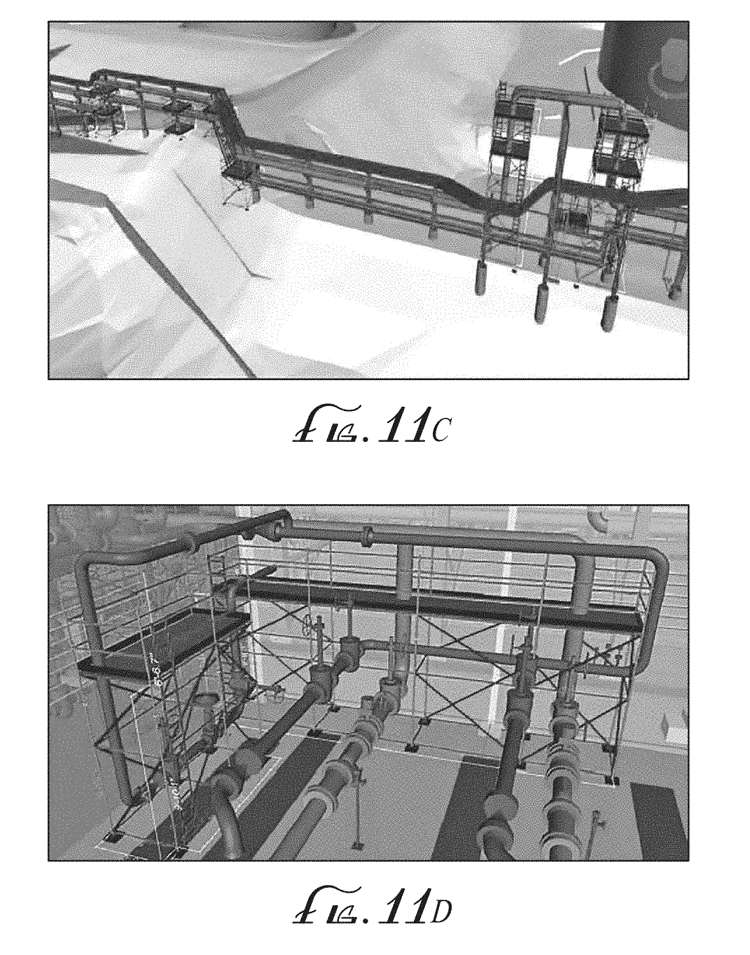

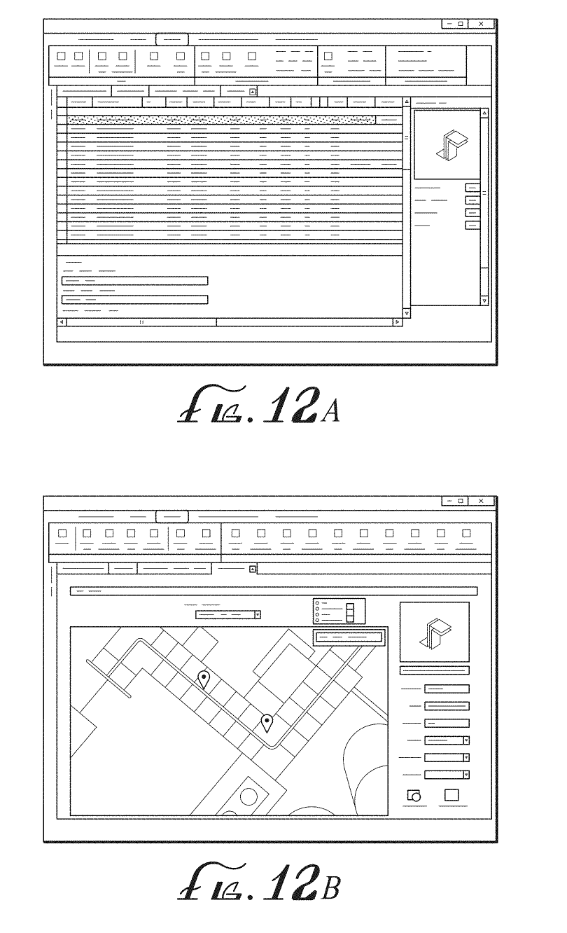

Some project-site models include GPS coordinates (or other positional identifiers). For those projects, the example scaffolding design software can be provided with the capability of use to design the scaffolding system with georeferenced multi-dimensional (e.g., 3-D) model elements, with the integrated/combined scaffolding/project model having the installed virtual scaffolding system georeferenced on the virtual project site, as shown for example in FIGS. 12A-B. And the example scaffolding design software can be used to create georeferenced multi-dimensional (e.g., 3-D) representations/models of other items to be used during the construction/renovation of the project facility (e.g., cranes, welding machines, ladders, and/or other construction equipment, materials, worker areas, roadways, etc.), with the integrated/combined scaffolding/project model having the item georeference-located on the project site where it is to be located during certain phases of construction (and still having the scaffolding system georeferenced on the project site), as shown for example in FIG. 13. The example scaffolding design software can also be used to output various views of the combination scaffolding/project model, including aerial aspects (see for example FIG. 13). The georeferencing feature (especially with the aerial aspects feature) better enables the designer to identify potential problems areas caused by the scaffolding design at 214. For example, by being able to view the construction crane model and its location on the project site model in FIG. 13, the designer is able to identify possible areas of interference with any element/location of the proposed scaffolding system at 214, modify the scaffolding design at 216, and (after reintegrating the modified scaffolding design with the project-site model back at 212) confirm the modification improves the scaffolding design back at 214.

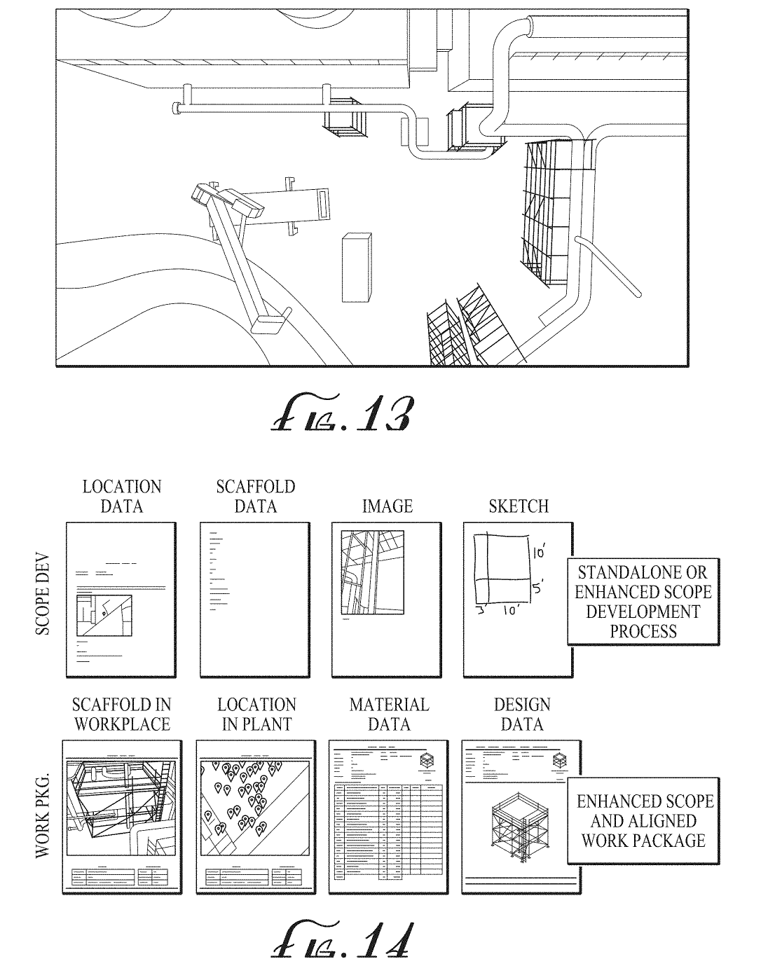

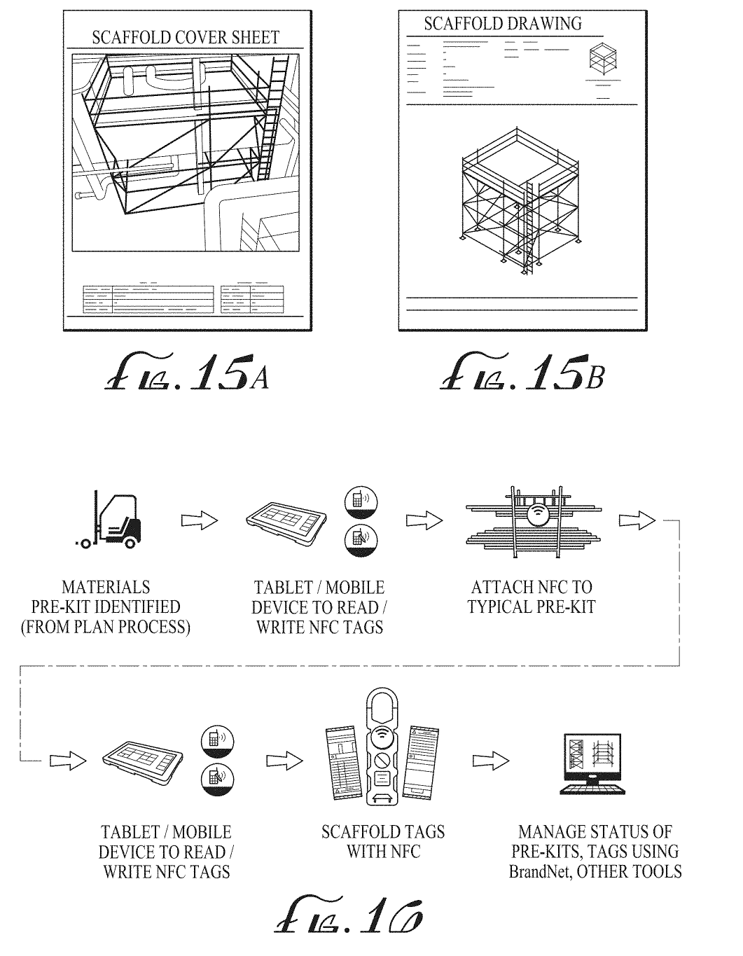

Once the scaffolding design is finalized, at 218 the designer uses the scaffolding design software to create and output a project-management work package. The output work package in example embodiments includes schematics of the scaffold design, construction instructions to be used at the project site, a list of materials and material data, cost estimates, and/or construction schedules, all based on the finalized design of the scaffolding system, as shown for example in FIGS. 14 and 15. The output work package can also include the combination integrated model of the scaffolding system overlaid onto the model of the project site, showing images depicting the scaffolding system in the workplace. If the project-site model includes GPS coordinates, the scaffolding software can also produce (and output for inclusion in the work package) maps depicting locations on the project site for installing the various scaffolding elements. These output elements of the work package can be used as a kit listing the materials and tools needed to construct the scaffolding system, thereby improving safety, quality, and productivity. Additionally, the work packages can be in a variety of formats allowing for multiple stakeholders to review and comment on appropriate issues related to the package, for example for viewing on laptop or handheld computer devices on the project site.

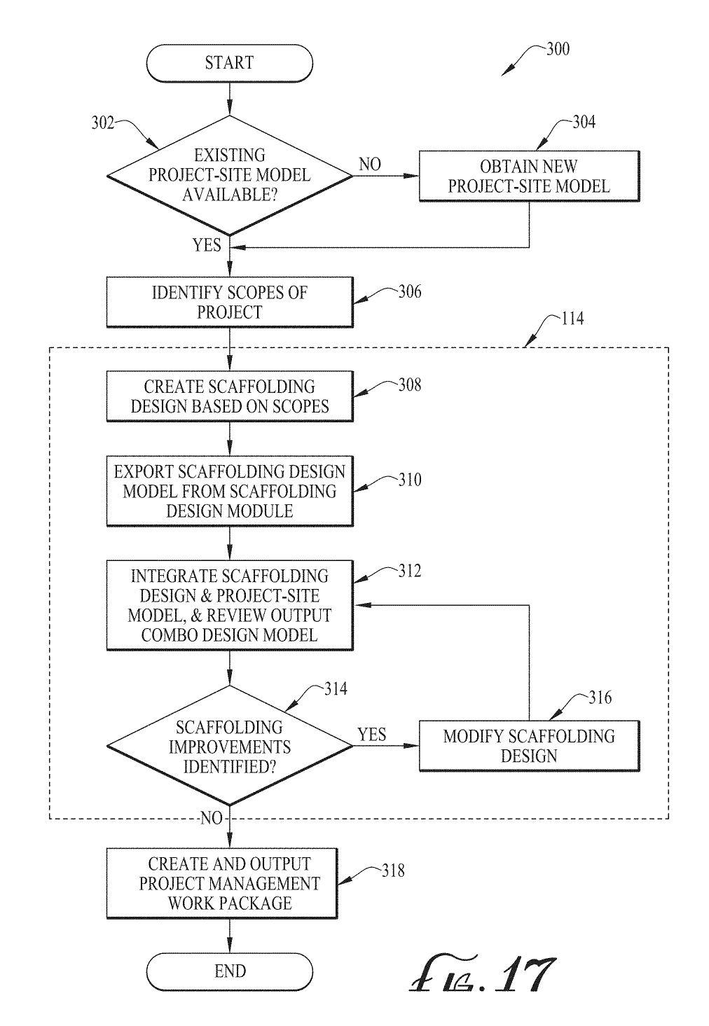

In addition, the designer can use the example scaffolding design software or other interoperable conventional software for identifying the GPS georeferenced location of the elements of the scaffolding system to enable production of a series of readable tags for the scaffolding system elements, for example as detailed in FIG. 16. In typical embodiments, the individual elements of the scaffolding system can be provided with individual/dedicated readable tags, for example near-field communication (NFC) tags, radio-frequency identification (RFID) tags, or matrix barcodes such as Quick Response (QR) codes or other barcodes. At the project site, the tags can be read, for example by a worker using a handheld, tablet, or other mobile electronic device with a scanner or other reader. When the tags are scanned or otherwise read on the project site, the scaffolding design or other software identifies correlated information (e.g., stored in a local or remote database) that relates to the corresponding part's installation location and assembly instructions, and then output displays that information on the mobile device's display screen. The scaffolding design or other software may also use the readable tags to manage the status of the individual scaffolding elements and the overall construction of the scaffolding system. This smart-tag feature can be included as an optional addition step of the method 200 or it can be included in conventional or other scaffolding design methods.

FIG. 17 shows a detailed design and improvement method 300 according to a second example embodiment. The method 300 includes the model-integration method 114 of and can be part of the overall scaffold design method 100 described above.

The design/improvement method 300 includes model-obtaining steps 302 and 304, which can be the same or similar to the model-obtaining steps 202 and 204 of the first embodiment method 200 of FIG. 2. The method 300 also includes scope-identification step 306, which can be the same or similar to the scope-identification step 206 of the first embodiment method 200 of FIG. 2. And the method 300 further includes a work-package output step 318, which can be the same or similar to the work-package output step 218 of the first embodiment method 200 of FIG. 2. This design/improvement method 300 differs (from the design/improvement method 200 of the first example embodiment) in its implementation of the model-integration 114 step of the overall scaffolding design method of FIG. 1.

In this design/improvement method 300, the scaffolding design is completed at step 308 as detailed above. Next, at step 310 the designer exports a model of the scaffolding design from the scaffolding design software system. The scaffolding design software exports the scaffolding-design model as a data file or in another format that can be imported into and viewed using conventional multi-dimensional (3-D) CAD software (design or viewer-only version) such as the AUTODESK system, the NAVISWORKS system, and the SMARTPLANT REVIEW system. The scaffolding-design software and the CAD software can be located on the same conventional computer used by the designer, or one or both can be located remotely from each other and/or the designer's computer but accessible via a network connection (e.g., the internet or a LAN). It will be understood that as used herein exporting the scaffolding-design model to the CAD software means the same thing as importing the scaffolding-design model into the CAD software.

Next, at 312 the designer uses the CAD software to integrate the exported scaffolding design model and the project-site model into a combination multi-dimensional spatial model of the scaffolding and the project-site (see for example FIGS. 10-11). The combination scaffolding/project model is displayed to allow the designer and/or the client to view the virtual scaffolding system installed at the virtual project site prior to actual physical on-site construction. This virtual viewing/planning feature better enables the designer or customer to identify potential problem areas caused by the scaffolding design at 314. Problems can include interference between the scaffolding and other site locations (e.g., as described above) needed for use during other aspects of the construction/renovation of the project facility. The virtual planning process also allows the designer to identify areas of interference (e.g., overlap) between multiple scaffolding elements that can be redesigned and covered by a single scaffolding element, thereby resulting in a scaffolding design providing for reduced time and cost at the construction phase. If problems are identified at 314, the scaffold design can be modified in the scaffolding design software at 316. The new/modified scaffold design can then be exported from the scaffolding design software at 310, again integrated with the project site model at 312, and re-reviewed by the designer and customer for any problems. This process can be repeated until a final version of the scaffolding design is achieved.

In another aspect, the invention relates to a system for planning, designing, and constructing scaffolding systems for a project site. The design system can be used to implement the design method described above and/or other similar methods including for example the scaffolding design and project-site model integration process for optimizing the scaffolding design. As such, the system includes a computer-implemented scaffolding design system, such as the BRANDNET tool described above or another software product. The system can also include laser-scanning equipment and a computer-implemented multi-dimensional modeling system (for the modeling project site based on the scanned data), such as that described above.

While the invention has been described with reference to example embodiments, it will be understood by those skilled in the art that a variety of modifications, additions, and deletions are within the scope of the invention, as defined by the following claims.

What is claimed is:

1. A scaffolding design method for a project site, the method comprising:
obtaining a multi-dimensional spatial model of the project site;
designing a scaffolding system model for the project site;
integrating the scaffolding-design model and the project-site model to generate a combination scaffold-design and project-site model;
reviewing the combination scaffolding-design and project-site model for possible problem areas in the scaffolding-design model; and
modifying the scaffolding-design model to include design improvements for the possible problem areas that are identified in the reviewing step, and reintegrating the modified scaffolding-design model into the project-site model to generate a modified combination scaffold-design and project-site model.

2. The method of claim 1, further comprising the step of repeating the reviewing and modifying steps until no further possible problem areas are identified.

3. The method of claim 1, wherein the step of obtaining a multi-dimensional spatial model of the project site includes obtaining an existing project-site model.

4. The method of claim 1, wherein the step of obtaining a multi-dimensional spatial model of the project site includes creating a new three-dimensional spatial model of the project site using laser-scanning equipment at the project site to capture scan data representing the project site.

5. The method of claim 4, wherein the step of creating a new three-dimensional spatial model of the project site further includes using scan-processing software to convert the captured scan data into a point cloud representation of the project site.

6. The method of claim 5, wherein the step of creating a new three-dimensional spatial model of the project site further includes using the scan-processing software to convert the point cloud representation into the project-site model.

7. The method of claim 1, wherein the step of integrating the scaffolding-design model and the project-site model to generate a combination scaffold-design and project-site model includes applying or overlaying the scaffolding-design model onto the project-site model.

8. The method of claim 1, wherein the step of integrating the scaffolding-design model and the project-site model to generate a combination scaffold-design and project-site model includes exporting the scaffolding-design model for use by a CAD software system that is operable to output for display the combination scaffold-design and project-site model.

9. The method of claim 1, wherein the reviewing step includes reviewing the combination scaffolding-design and project-site model for possible problem areas including potential interferences between elements of the scaffolding scaffolding-design model and construction locations in the project-site model.

10. The method of claim 9, wherein the construction locations in the project-site model include site locations that need to be kept clear for placing construction equipment or materials, or for access by workers or equipment, during construction on the project site.

11. The method of claim 1, wherein the reviewing step includes reviewing the combination scaffolding-design and project-site model for possible problem areas including site locations where two elements of scaffolding can be replaced with one element of scaffolding.

12. The method of claim 1, wherein the project-model site includes georeferenced site elements, wherein the designing step includes designing a scaffolding system model with georeferenced scaffolding elements, and wherein the integrating step includes georeferencing the georeferenced scaffolding elements to respective ones of the georeferenced site elements.

13. The method of claim 12, further comprising the step of providing georeferenced readable tags for the respective georeferenced scaffolding elements for use in determining respective installation locations of the georeferenced scaffolding elements.

14. The method of claim 1, further comprising the step of generating a project-management work package including at least one of a schematic, element list, construction instructions, construction schedule, and cost estimate.

15. A system for implementing the method of claim 1, comprising:
a scan-processing software module that is operable to convert data collected from laser scanning the project site into the project-site model;
a scaffolding-design software module that is operable to design the scaffolding-design model for integration with the project-site model; and
a CAD software module that is operable to import the scaffolding-design model and integrate it with the project-site model to generate the combination scaffold-design and project-site model.

16. A scaffolding design method for a project site, the method comprising:
obtaining a multi-dimensional spatial model of the project site by laser scanning the project site to capture scan data representing the project site, converting the captured scan data into a point cloud representation of the project site, and converting the point cloud representation into the project-site model;
identifying access locations of the project site;
designing a scaffolding system model for the project site based on the access locations;
integrating the scaffolding-design model and the project-site model, by exporting the scaffolding-design model and then applying or overlaying the scaffolding-design model onto the project-site model, to generate a combination scaffold-design and project-site model;
reviewing the combination scaffolding-design and project-site model for possible problem areas in the scaffolding-design model, wherein the possible problem areas include potential interferences between elements of the scaffolding scaffolding-design model and construction locations in the project-site model, or between multiple elements of the scaffolding scaffolding-design model, and wherein the construction locations in the project-site model include site locations that need to be kept clear for placing construction equipment or materials, or for access by workers or equipment, during construction on the project site; and
modifying the scaffolding-design model to include design improvements for the possible problem areas that are identified in the reviewing step, reintegrating the modified scaffolding-design model into the project-site model to generate a modified combination scaffold-design and project-site model, and repeating the reviewing and modifying steps until no further possible problem areas are identified.

17. The method of claim 16, wherein the integrating step includes exporting the scaffolding-design model into a CAD software system that is operable to apply or overlay the scaffolding-design model onto the project-site model and output for display the combination scaffold-design and project-site model.

18. The method of claim 16, wherein the project-model site includes georeferenced site elements, wherein the designing step includes designing a scaffolding system model with georeferenced scaffolding elements, and wherein the integrating step includes georeferencing the georeferenced scaffolding elements to respective ones of the georeferenced site elements.

19. The method of claim 18, further comprising the step of providing georeferenced readable tags for the respective georeferenced scaffolding elements for use in determining respective installation locations of the georeferenced scaffolding elements.

20. A system for implementing the method of claim 16, comprising:
laser-scanning equipment operable to capture the scan data representing the project site;
a scan-processing software module operable to convert the captured scan data into a point cloud representation of the project site and convert the point cloud representation into the project-site model;
a scaffolding-design software module that is operable to design the scaffolding-design model for integration with the project-site model; and
a CAD software module that is operable to import the scaffolding-design model and integrate it with the project-site model to generate the combination scaffold-design and project-site model.
